(19) United States
(12) Patent Application Publication
(10) Pub. No.: US 2022/0390316 A1
(43) Pub. Date: Dec. 8, 2022

(54) SYSTEM AND METHOD FOR DETECTING DEVELOPMENT OF A LEAK IN THE DRY PIPE SECTION OF A DRY PIPE SPRINKLER SYSTEM

(71) Applicant: Jason Paul Hedeen, Wayzata, MN (US)

(72) Inventor: Jason Paul Hedeen, Wayzata, MN (US)

(21) Appl. No.: 17/664,670

(22) Filed: May 24, 2022

Related U.S. Application Data
(60) Provisional application No. 63/196,293, filed on Jun. 3, 2021.

(51) Int. Cl. G01M 3/28; A62C 37/50

(52) U.S. Cl. CPC G01M 3/2807; A62C 37/50

(57) ABSTRACT

A pressure maintenance system for a dry pipe sprinkler system programmed to store and report compressor activation data from which development of a leak in a dry pipes section of a dry pipe sprinkler system can be ascertained based upon an abnormal increase in activation of the compressor, and a method for detecting development of a leak in a dry pipes section of a dry pipe sprinkler system employing the pressure maintenance system.

### BACKGROUND

A dry pipe sprinkler system is a fire suppression sprinkler system in which pipes are filled with a pressurized gas rather than water. The gas holds a remote valve, known as a dry pipe valve, in a closed position. Located in a heated space, the dry-pipe valve prevents water from entering the pipe until a fire causes one or more sprinklers to operate. Once this happens, the gas escapes and the dry pipe valve is released. Water then enters the pipe, flowing through open sprinklers and onto the fire.

Gas pressure is maintained within the pipes by a compressor unit, which monitors the pressure within the pipes and increases the pressure within the pipes whenever the pressure falls below a threshold minimum pressure.

On occasion one or more leaks of consequence develop in the dry pipes, causing an ongoing amplified loss of pressure within the dry pipes and thereby a concomitant increase in the frequency of compressor unit operation as the compressor unit seeks to compensate for the amplified loss in pressure. The resultant excessive operation of the compressor unit results in unnecessary wear and tear on the compressor unit and eventually premature failure of the unit.

Discovery of such leaks currently occurs only by happenstance, such as by fortuitous auditory discovery of the leak or chance observation of the compressor unit activating several times within a short time period.

Accordingly, a substantial need exists for a system and method capable of providing timely detection and reporting of a leak in the dry pipe section of a dry pipe sprinkler system.

### SUMMARY OF THE INVENTION

A first aspect of the invention is a pressure maintenance system for a dry pipe sprinkler system programmed to store and report compressor activation data from which development of a leak in a dry pipes section of a dry pipe sprinkler system can be ascertained. The pressure maintenance system includes at least (-) a compressor, (-) a pressure switch in electrical communication with the compressor and operable for communicating with the gaseous content of the dry pipes section of a dry pipe sprinkler system for activating the compressor as necessary to maintain a target elevated pressure within the dry pipes section, and (-) a processing unit with electronic memory.

In a first embodiment the processing unit is operable for (i) tracking and recording the number of times the compressor is activated within a time period for a plurality of non-overlapping time periods of defined identical duration to establish an activation occurrence numerical value for each of the time periods, and (ii) reporting the activation occurrence numerical value for a plurality of the time periods, whereby development of a leak in the dry pipes section is indicated by an abnormal increase in the activation occurrence numerical value.

In a second embodiment the processing unit is operable for (i) tracking and recording the number of times the compressor is activated within first and second time periods to establish first and second activation frequency values respectively, and (ii) reporting the first and second activation frequency values whereby an abnormal increase in activation frequency value indicates development of a leak in the dry pipes section.

In a third embodiment the processing unit is operable for (i) tracking and recording the number of times the compressor is activated within a first extended time period and a second condensed time period to establish a baseline activation frequency value and a recent activation frequency value respectively, and (ii) reporting the baseline activation frequency value and recent activation frequency value whereby an abnormal increase in activation frequency from the baseline activation frequency value to the recent activation frequency value indicates development of a leak in the dry pipes section. The first extended time period is preferably several times longer than the second condensed time period.

A second aspect of the invention is a method for detecting development of a leak in a dry pipes section of a dry pipe sprinkler system for enabling timely repair of the leak.

In a first embodiment the method includes the steps of (i) maintaining a target elevated pressure within the dry pipes section with a pressure maintenance system in accordance with the first embodiment of the first aspect of the invention, and (ii) triggering a service repair event to locate and repair a leak in the dry pipes section when the activation occurrence numerical value for one time period exceeds the activation occurrence numerical value for an earlier time period by a threshold numerical value indicative of the development of a leak in the dry pipes section.

In a second embodiment the method includes the steps of (i) maintaining a target elevated pressure within the dry pipes section with a pressure maintenance system in accordance with the second embodiment of the first aspect of the invention, and (ii) triggering a service repair event to locate and repair a leak in the dry pipes section when the second activation frequency value exceeds the first activation frequency value by a threshold numerical value indicative of the development of a leak in the dry pipes section.

In a third embodiment the method includes the steps of (i) maintaining a target elevated pressure within the dry pipes section with a pressure maintenance system in accordance with the second embodiment of the first aspect of the invention, and (ii) triggering a service repair event to locate and repair a leak in the dry pipes section when the recent activation frequency value exceeds the baseline activation frequency value by a threshold numerical value indicative of the development of a leak in the dry pipes section.

### BRIEF DESCRIPTION OF THE DRAWINGS

FIG. 1 is a schematic view of one embodiment of the invention.

FIG. 2 is a schematic view of the individual components of the control unit depicted in FIG. 1.

### DETAILED DESCRIPTION OF A PREFERRED EMBODIMENT

Nomenclature Table
100 Dry Pipe Sprinkler Compressor Unit
120 Compressor
130 Pressure Tank
140 Control Unit or Digital Differential Pressure Switch
142 Pressure Sensor
144 Pressure Switch
146 Processor
150 Display and User Interface
160 Pressurized Air Pipes
170 Electrical Leads
SD Dry Pipes in a Dry Pipe Sprinkler System

### DESCRIPTION

### Dry Pipe Sprinkler Compressor Unit 100

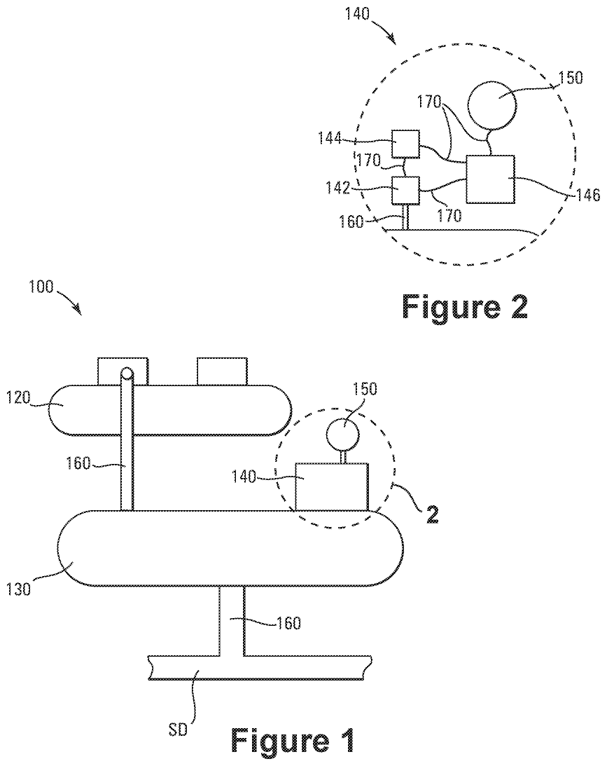

Referring to FIGS. 1 and 2, the invention is a dry pipe sprinkler compressor unit 100 configured and arranged for use with a dry pipe sprinkler system, equipped to store and report compressor activation data from which development of a leak in a dry pipes section of a dry pipe sprinkler system can be ascertained.

The dry pipe sprinkler compressor unit 100 includes (i) an air compressor 120, (ii) a pressure tank 130, (iii) a control unit 140 including a pressure sensor 142, a pressure switch 144 and a processor 146, (iv) air pipes 160 for placing certain components into fluid communication with one another, and (v) electrical leads 170 for placing certain components into electrical communication with one another.

The air compressor 120 is mounted upon a frame (not shown), such as by threaded vibration dampeners, washers and nuts.

The pressure tank 130 is mounted upon the same frame, such as by screws, washers and nuts, and placed in fluid communication with the air compressor 120, such as via a metal hose 160 preferably equipped with a check valve, a safety valve and strain relief wire clasps, for receiving air pressurized by the air compressor 120. The pressure tank 130 preferably includes a drain valve.

The pressure sensor 142 is in fluid communication with compressed air in the pressure tank 130, such as via tube 160, for generating a low pressure signal when the pressure in the pressure tank 130 falls below a threshold value.

The pressure switch 144 is in electrical communication with the pressure sensor 142 and the air compressor 120 for activating the air compressor 120 upon receipt of the low pressure signal from the pressure sensor 142 so as to supply the pressure tank 130 with additional pressurized air.

In a preferred embodiment the pressure sensor 142 and pressure switch 144 are consolidated in an adjustable digital differential pressure switch 140.

The adjustable digital differential pressure switch 140 is in fluid communication with compressed air in the pressure tank 130 and in communication with the air compressor 120 for activating the air compressor 120 upon sensing a pressure in the pressure tank 130 at or below a preset minimum pressure value, and deactivating the air compressor 120 upon sensing a pressure in the pressure tank 130 at or above a preset maximum pressure value. The adjustable digital differential pressure switch 140 is preferably operable for user input, adjustment and visual display 150 during user input or adjustment of at least two pressure values selected from (i) a minimum pressure value, (ii) a maximum pressure value, and (iii) a pressure differential between a minimum pressure value and a maximum pressure value.

In a most preferred embodiment, the adjustable digital differential pressure switch 140 has a mandated and default pressure differential of at least 4 psi, preferrably between 4 and 20 psi, and most preferably between 4 and 10 psi.

Specification details for one preferred embodiment of the dry pipe sprinkler compressor unit 100 is provided below in Table One.

TABLE ONE
FIRST PREFERRED EMBODIMENT

| HP | 1 | |
|---|---|---|
| SYSTEM CAPACITY | 40 PSI 260 GALLONS | |
| | 20 PSI 520 GALLONS | |
| | 10 PSI 1040 GALLONS | |
| PRESSURE SWITCH | ON @55 PSI, OFF @ 120 PSI | |
| CFM | 2.35 @90 PSI | |
| PUMP | 2 CYLINDER, OIL FREE | |
| CYLINDERS | CERAMIC COMPOSITE | |
| VOLTS | 115 | |
| PHASE | 1 | |
| TANK SIZE | 1 | GALLON |
| OUTLET | ½″ | NPT |
| DIMENSIONS | 36″ × 10.5″ × 7″ | |
| WEIGHT | 42 | LBS. |

Specification details for another preferred embodiment of the dry pipe sprinkler compressor unit 100 is provided below in Table Two.

TABLE TWO
SECOND PREFERRED EMBODIMENT

| HP | 1 | |
|---|---|---|
| SYSTEM CAPACITY | 40 PSI 261 GALLONS | |
| | 20 PSI 522 GALLONS | |
| | 10 PSI 1200 GALLONS | |
| PRESSURE SWITCH | ADJUSTABLE: 5-55 PSI | |
| | Factory Set at 15-20 PSI | |
| | Minimum Differential: 5 PSI | |
| CFM | 3.68 @10 PSI | |
| PUMP | 2 CYLINDER, OIL FREE | |
| CYLINDERS | CERAMIC COMPOSITE | |
| VOLTS | 115 | |
| PHASE | 1 | |
| OUTLET | ¾″ | NPT |
| DIMENSIONS | 27″ × 10.5″ × 7″ | |
| WEIGHT | 38 | LBS. |

### Installation and Use

The dry pipe sprinkler compressor unit 100 can be quickly, easily, stably and securely mounted onto a vertical surface, placed into operable engagement with a dry pipe sprinkler system, and then set and adjusted for providing proper pressurization to the dry side of a dry pipe valve.

Referring to FIG. 1, the pressure tank 130 is placed in fluid communication with the dry side of a dry pipe valve for filling the dry pipes SD with pressurized gas at a pressure sufficient to keep the dry pipe valve V closed. Of course, when one or more sprinklers (unnumbered) on the dry pipes SD is opened the pressurized gas escapes, the dry pipe valve opens, and pressurized water from the water pipes in fluid communication with the wet side of the dry pipe valve flows into the dry pipes SD and out through the open sprinkler(s).

The threshold pressures at which the pressure switch 144 activates and deactivates the air compressor 120 to maintain an appropriate pressure within the pressure tank 130 may be set mechanically or by input to the processor 146 via the display and user interface 150.

For example, mechanical setting of the pressure threshold values may be made by mechanical rotation of an adjustment screw (not individually shown) on the pressure switch 144 until readings on the display and user interface 150 received from the pressure sensor 142, taken at times of activation and deactivation, indicate achievement of desired threshold settings.

Alternatively, programmed setting and control of the pressure threshold values may be made by inputting the desired values to processor 146 which is in electrical communication with the pressure switch 144. By way of example, the display and user interface 150 may be equipped with three input buttons (not shown) labeled mode, up arrow and down arrow. An initial pressing of the mode button displays a request for input of a maximum threshold pressure value at which the air compressor 120 will be shut off. The up arrow and down arrow are used to set this value. Pressing the mode button again sets the maximum threshold pressure value, and displays a request for input of a minimum threshold pressure value at which the air compressor 120 will be turned on. The up arrow and down arrow are used to set this value.

In a preferred embodiment, the processor 146 is preprogrammed with a default minimum pressure differential between the minimum and maximum and threshold pressure values (e.g., a mandated pressure differential of at least 4 psi, preferably a mandated pressure differential of between 4 and 20 psi, and most preferably a mandated pressure differential of between 4 and 10 psi) so as to prevent setting of the minimum and maximum and threshold pressure values too close to one another in order to avoid excessive wear resulting from overly frequent activation of the air compressor 120.

In another example, the display and user interface 150 may be equipped with three input buttons (not shown) labeled mode, up arrow and down arrow. An initial pressing of the mode button displays a request for input of a minimum threshold pressure value at which the air compressor 120 will be turned on. The up arrow and down arrow are used to set this value. Pressing of the mode button again sets the minimum threshold pressure value, and displays a request for input of a pressure differential between the selected minimum and a maximum threshold pressure value, thereby setting the maximum threshold pressure value at which the air compressor 120 will be turned off. The up arrow and down arrow are used to set this value.

In a preferred embodiment, the processor 146 is preprogrammed to prevent setting of the pressure differential too tightly (e.g., a mandated pressure differential of at least 4 psi, preferably a mandated pressure differential of between 4 and 20 psi, and most preferably a mandated pressure differential of between 4 and 10 psi) to avoid excessive wear resulting from overly frequent activation of the air compressor 120.

The processor 146 may be programmed to allow locking and unlocking of the pressure setting feature, and may be programmed to allow monitoring and display of the amps voltage of the electrical current to the air compressor 120.

### Leak Detection Feature

The processor 146 onboard the dry pipe sprinkler compressor unit 100 can be programmed to facilitate detection of a leak in a dry sprinkle system in fluid communication with the dry pipe sprinkler compressor unit 100.

### First Embodiment

In a first embodiment the processor 146 is programmed to (i) track and record the number of times the compressor 120 is activated within a time period for a plurality of non-overlapping time periods of defined identical duration to establish an activation occurrence numerical value for each of the time periods, and (ii) report the activation occurrence numerical value for a plurality of the time periods, whereby development of a leak in the dry pipes section is indicated by an abnormal increase in the activation occurrence numerical value.

The time period is preferably between 2 and 48 hours, more preferably between 4 and 12 hours, and most preferably between 6 and 8 hours.

The duration of the time period preferably includes at least four activations of the compressor 120.

In use, the dry pipe sprinkler compressor unit 100 would maintain a target elevated pressure within the dry pipes section SD and trigger a service repair event to locate and repair a leak in the dry pipes section SD when the activation occurrence numerical value for one time period exceeds the activation occurrence numerical value for an earlier time period by a threshold numerical value indicative of the development of a leak in the dry pipes section SD.

A human perceptible signal (e.g., audible tone or visual signal) is preferably generated on the display and user interface 150 when the activation occurrence numerical value for a more recent time period exceeds the activation occurrence numerical value for a prior time period by a threshold numerical value indicative of the development of a leak in the dry pipes section SD.

The threshold numerical value is preferably between 20% and 100% and more preferably between 50% and 100%. Alternatively, the threshold numerical value is preferably between two and ten additional activations of the compressor 120, most preferably between four and ten additional activations of the compressor 120.

### Second Embodiment

In a second embodiment the processor 146 is programmed to (i) track and record the number of times the compressor 120 is activated within first and second time periods to establish first and second activation frequency values respectively, and (ii) report the first and second activation frequency values whereby an abnormal increase in activation frequency value indicates development of a leak in the dry pipes section.

The first and second time periods are preferably of different duration. The first time period can be at least three times longer than the second time period, with a preference for at least five time longer and more preferably at least then times longer.

The time period is preferably between 2 and 48 hours, more preferably between 4 and 12 hours, and most preferably between 6 and 8 hours.

The duration of the time period preferably includes at least four activations of the compressor 120.

In use, the dry pipe sprinkler compressor unit 100 would maintain a target elevated pressure within the dry pipes section SD and trigger a service repair event to locate and repair a leak in the dry pipes section SD when the second activation frequency value exceeds the first activation frequency value by a threshold numerical value indicative of the development of a leak in the dry pipes section SD.

A human perceptible signal (e.g., audible tone or visual signal) is preferably generated on the display and user interface 150 when the difference in activation frequency values exceeds a threshold numerical value indicative of the development of a leak in the dry pipes section SD.

The threshold numerical value is preferably between 50% and 200% and more preferably between 100% and 200%. Alternatively, the threshold numerical value is preferably between two and ten additional activations of the compressor 120, most preferably between four and ten additional activations of the compressor 120.

### Third Embodiment

In a third embodiment the processor 146 is programmed to (i) track and record the number of times the compressor 120 is activated within a first extended time period and a second condensed time period to establish a baseline activation frequency value and a recent activation frequency value respectively, and (ii) report the baseline activation frequency value and recent activation frequency value whereby an abnormal increase in activation frequency from the baseline activation frequency value to the recent activation frequency value indicates development of a leak in the dry pipes section. The first extended time period is preferably several times longer than the second condensed time period.

The first extended and second condensed time periods are preferably of different duration with the first extended time period longer than the second condensed time period. The first extended time period and second condensed time period may be distinct or overlapping time periods. The first extended time period can be at least three times longer than the second condensed time period, with a preference for at least five time longer and more preferably at least then times longer.

Preferably, the first extended time period is between 3 and 21 days and the second condensed time period is between 2 and 48 hours. More preferably, the first extended time period is between 3 and 14 days and the second condensed time period is between 4 and 12 hours. Most preferably, the first extended time period is between 4 and 14 days and the second condensed time period is between 6 and 8 hours.

The first extended time period preferably includes at least four activations of the compressor 120.

In use, the dry pipe sprinkler compressor unit 100 would maintain a target elevated pressure within the dry pipes section SD and trigger a service repair event to locate and repair a leak in the dry pipes section SD when the second activation frequency value exceeds the first activation frequency value by a threshold numerical value indicative of the development of a leak in the dry pipes section SD.

A human perceptible signal (e.g., audible tone or visual signal) is preferably generated on the display and user interface 150 when the difference in activation frequency values exceeds a threshold numerical value indicative of the development of a leak in the dry pipes section SD.

The threshold numerical value is preferably between 100% and 300% and more preferably between 100% and 200%.

In use, the dry pipe sprinkler compressor unit 100 would maintain a target elevated pressure within the dry pipes section SD and trigger a service repair event to locate and repair a leak in the dry pipes section SD when the recent activation frequency value exceeds the baseline activation frequency value by a threshold numerical value indicative of the development of a leak in the dry pipes section SD.

Activation occurrence numerical values are preferably displayed in human perceptible form for all embodiments, such as upon the display and user interface 150 upon user request.

Provided below is TABLE THREE providing exemplary compressor activation data in accordance with the first and second embodiments of the pressure maintenance system of the invention, and TABLE FOUR providing exemplary compressor activation data in accordance with the second and third embodiments of the pressure maintenance system of the invention.

TABLE THREE
Duration of Time Periods = 8 hours
First and Second Alternating Time Periods

| Time Since | | | | | |
|---|---|---|---|---|---|
| Pressurization | Compressor Activations | | Displayed Data | | |
| of Dry Pipes | within Time Period | | 1^{st} Period | 2^{nd} Period | Indication of |
| (hours) | 1^{st} Period | 2^{nd} Period | (# Activations) | (# Activations) | New Leak |
| 8 | 1 | — | 1 | — | No |
| 16 | — | 1 | 1 | 1 | No |
| 24 | 2 | — | 2 | 1 | No |
| 32 | — | 2 | 2 | 2 | No |
| 40 | 4 | — | 4 | 2 | Yes |
| 48 | — | 4 | 4 | 4 | No |

TABLE FOUR
Duration of First Time Period = Last 48 hours
Duration of Second Time Period = Last 12 hours
First and Second Time Periods Overlapping and Rolling

| | | | Displayed Data | | |
|---|---|---|---|---|---|
| Time Since | | | 1^{st} Period | 2^{nd} Period | |
| Pressurization | Compressor Activations | | (Activation | (Activation | |
| of Dry Pipes | within Time Period | | Frequency per | Frequency per | Indication of |
| (hours) | 1^{st} Period | 2^{nd} Period | 12 hrs) | 12 hrs) | New Leak |
| 12 | — | 1 | — | 1 | No |
| 24 | — | 0 | — | 0 | No |
| 36 | — | 1 | — | 1 | No |
| 48 | — | 0 | — | 0 | No |
| 60 | 2 | 1 | 0.50 | 1 | No |
| 72 | 2 | 0 | 0.50 | 0 | No |
| 84 | 2 | 1 | 0.50 | 1 | No |
| 96 | 2 | 0 | 0.50 | 0 | No |
| 108 | 2 | 2 | 0.50 | 2 | Yes |
| 120 | 3 | 4 | 0.75 | 4 | Yes |
| 132 | 7 | 5 | 1.75 | 5 | Yes |
| 144 | 11 | 4 | 2.75 | 4 | Yes |
| 156 | 15 | 6 | 3.75 | 6 | Yes |
| 168 | 19 | 5 | 4.75 | 5 | No |
| 180 | 20 | 6 | 5 | 6 | No |

I claim:

1. A pressure maintenance system for a dry pipe sprinkler system programmed to store and report compressor activation data from which development of a leak in a dry pipes section of a dry pipe sprinkler system can be ascertained, comprising:
(a) a compressor,
(b) a pressure switch in electrical communication with the compressor and operable for communicating with the gaseous content of the dry pipes section of the dry pipe sprinkler system for activating the compressor as necessary to maintain a target elevated pressure within the dry pipes section, and
(c) a processing unit with electronic memory for:
(i) tracking and recording the number of times the compressor is activated within a time period for a plurality of non-overlapping time periods of defined identical duration to establish an activation occurrence numerical value for each of the time periods, and
(ii) reporting the activation occurrence numerical value for a plurality of the time periods, whereby development of a leak in the dry pipes section is indicated by an abnormal increase in the activation occurrence numerical value.

2. The pressure maintenance system of claim 1 wherein the processing unit compares the activation occurrence numerical values for two different time periods and generates a human perceptible signal when the activation occurrence numerical value for a more recent time period exceeds the activation occurrence numerical value for a prior time period by a threshold numerical value indicative of the development of a leak in the dry pipes section.

3. The pressure maintenance system of claim 1 wherein the time period is between 2 and 48 hours.

4. The pressure maintenance system of claim 1 wherein the duration of the time period includes at least four activations of the compressor.

5. The pressure maintenance system of claim 2 wherein the duration of the time period includes at least four activations of the compressor.

6. The pressure maintenance system of claim 2 wherein the threshold numerical value is between 20% and 100%.

7. The pressure maintenance system of claim 2 wherein the threshold numerical value is between two and ten additional activations of the compressor.

8. A pressure maintenance system for a dry pipe sprinkler system programmed to store and report compressor activation data from which development of a leak in a dry pipes section of a dry pipe sprinkler system can be ascertained, comprising:
(a) a compressor,
(b) a pressure switch in electrical communication with the compressor and operable for communicating with the gaseous content of the dry pipes section of the dry pipe sprinkler system for activating the compressor as necessary to maintain a target elevated pressure within the dry pipes section, and
(c) a processing unit with electronic memory for:
(i) tracking and recording the number of times the compressor is activated within first and second time periods to establish first and second activation frequency values respectively, and
(ii) reporting the first and second activation frequency values whereby an abnormal increase in activation frequency value indicates development of a leak in the dry pipes section.

9. The pressure maintenance system of claim 8 wherein the first time period and the second time period are of different duration.

10. The pressure maintenance system of claim 8 wherein the first time period is at least three times longer than the second time period.

11. The pressure maintenance system of claim 8 wherein the processing unit compares the first and second activation frequency values and generates a human perceptible signal when the difference in activation frequency values exceeds a threshold numerical value indicative of the development of a leak in the dry pipes section.

12. The pressure maintenance system of claim 8 wherein the time period is between 2 and 48 hours.

13. The pressure maintenance system of claim 8 wherein the duration of the time period includes at least four activations of the compressor.

14. The pressure maintenance system of claim 11 wherein the duration of the time period includes at least four activations of the compressor.

15. The pressure maintenance system of claim 11 wherein the threshold numerical value is between 50% and 200%.

16. The pressure maintenance system of claim 11 wherein the threshold numerical value is between two and ten additional activations of the compressor.

17. A pressure maintenance system for a dry pipe sprinkler system programmed to store and report compressor activation data from which development of a leak in a dry pipes section of a dry pipe sprinkler system can be ascertained, comprising:
(a) a compressor,
(b) a pressure switch in electrical communication with the compressor and operable for communicating with the gaseous content of the dry pipes section of the dry pipe sprinkler system for activating the compressor as necessary to maintain a target elevated pressure within the dry pipes section, and
(c) a processing unit with electronic memory for:
(i) tracking and recording the number of times the compressor is activated within a first extended time period and a second condensed time period to establish a baseline activation frequency value and a recent activation frequency value respectively, and
(ii) reporting the baseline activation frequency value and recent activation frequency value whereby an abnormal increase in activation frequency from the baseline activation frequency value to the recent activation frequency value indicates development of a leak in the dry pipes section.

18. The pressure maintenance system of claim 17 wherein the first extended time period and the second condensed time period are of different duration.

19. The pressure maintenance system of claim 17 wherein the first extended time period is at least three times longer than the second condensed time period.

20. The pressure maintenance system of claim 17 wherein the processing unit compares the baseline activation frequency value and recent activation frequency value and generates a human perceptible signal when the difference in activation frequency values exceeds a threshold numerical value indicative of the development of a leak in the dry pipes section.

21. The pressure maintenance system of claim 17 wherein the first extended time period is longer than and inclusive of the second condensed time period.

22. The pressure maintenance system of claim 17 wherein the first extended time period is between 3 and 21 days and the second condensed time period is between 2 and 48 hours.

23. The pressure maintenance system of claim 17 wherein the first extended time period includes at least four activations of the compressor unit.

24. The pressure maintenance system of claim 17 wherein the threshold numerical value is between 100% and 300%.

25. A method for detecting development of a leak in a dry pipes section of a dry pipe sprinkler system for enabling timely repair of the leak, comprising the steps of:
(a) maintaining a target elevated pressure within the dry pipes section with a pressure maintenance system in accordance with claim 1, and
(b) triggering a service repair event to locate and repair a leak in the dry pipes section when the activation occurrence numerical value for one time period exceeds the activation occurrence numerical value for an earlier time period by a threshold numerical value indicative of the development of a leak in the dry pipes section.

26. A method for detecting development of a leak in a dry pipes section of a dry pipe sprinkler system for enabling timely repair of the leak, comprising the steps of:
(a) maintaining a target elevated pressure within the dry pipes section with a pressure maintenance system in accordance with claim 15, and
(b) triggering a service repair event to locate and repair a leak in the dry pipes section when the second activation frequency value exceeds the first activation frequency value by a threshold numerical value indicative of the development of a leak in the dry pipes section.

27. A method for detecting development of a leak in a dry pipes section of a dry pipe sprinkler system for enabling timely repair of the leak, comprising the steps of:
(a) maintaining a target elevated pressure within the dry pipes section with a pressure maintenance system in accordance with claim 33, and
(b) triggering a service repair event to locate and repair a leak in the dry pipes section when the recent activation frequency value exceeds the baseline activation frequency value by a threshold numerical value indicative of the development of a leak in the dry pipes section.
